(19) United States
(12) Patent Application Publication
(10) Pub. No.: US 2008/0185877 A1
(43) Pub. Date: Aug. 7, 2008

(54) Composite Material for a Folding Vehicle Roof and Method for Production of a Composite Material

(75) Inventor: Jutta Sommer, Rheine (DE)

Correspondence Address: QUINN LAW GROUP, PLLC, 39555 ORCHARD HILL PLACE, SUITE # 520, NOVI, MI, 48375, US

(73) Assignee: WILHELM KARMANN GMBH, Osnabruck (DE)

(21) Appl. No.: 11/815,828

(22) PCT Filed: Feb. 2, 2006
(86) PCT No.: PCT/DE06/00154

§ 371 Date: Oct. 30, 2007

(30) Foreign Application Priority Data
Feb. 10, 2005 (DE) 10 2005 006 033.1
Feb. 2, 2006 (DE) PCT/DE06/000154

(51) Int. Cl. B60J 7/00; B29C 65/00

(52) U.S. Cl. 296/211; 156/60

(57) ABSTRACT

A composite material for a folding vehicle roof of a convertible vehicle is provided in which a lower layer that faces the interior of a vehicle when the vehicle roof is closed is constructed at least in part as a woven textile layer, which is bonded on its side that faces away from the interior of the vehicle when the vehicle roof is closed to a leather layer via an intermediate layer and characterized in that on the side of the leather layer that faces an intermediate layer, which serves to improve the water impermeability of the composite material, an intermediate layer that impregnates the leather layer and also serves to improve the water impermeability of the composite material, along with strengthening a bond between the leather layer and the intermediate layer, is applied.

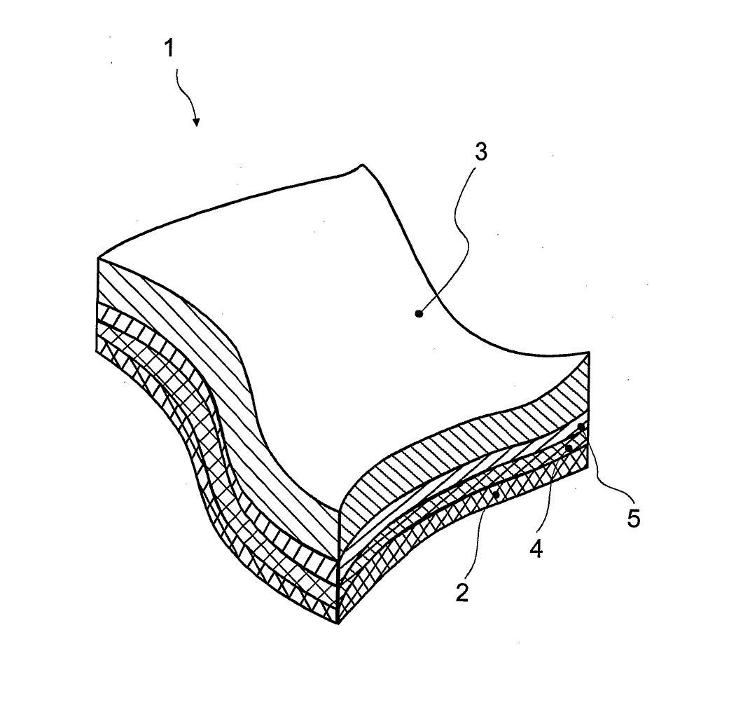

### CROSS-REFERENCE TO RELATED APPLICATION(S)

This application is a US National Phase of International Application No. PCT/DE 2006/000154, filed Feb. 2, 2006, which claims priority to German 10 2005 006 033.1 filed Feb. 10, 2005. The entire contents of the above identified applications are incorporated herein by reference.

### TECHNICAL FIELD

The invention relates to a composite material for a folding vehicle roof, and a method for producing such a composite material, in which a lower layer that faces the interior of a vehicle when the vehicle roof is closed is at least partly configured as a woven textile layer.

### BACKGROUND OF THE INVENTION

Convertible vehicles known in practical use are configured to comprise a vehicle roof that can be transferred from a first position, in which it covers the interior of a vehicle, to a second position, in which it opens up the interior of the vehicle. So-called folding tops require less stowage space in the stowed position than so-called RHT roofs (Retractable Hard Top).

With the folding tops that require less stowage space, when the vehicle roof is closed a flexible top cover is held in place by top elements that extend in the longitudinal direction of the vehicle and in the transverse direction of the vehicle, and when the vehicle roof is opened, it is folded down together with the top elements and stowed in a stowage area.

Among others, leather folding tops are known in practical use, the flexible top covers of which are made of leather, giving a convertible vehicle a highly exclusive overall look.

However, over the life of the vehicle the leather becomes increasingly brittle and crumbly, thus a permanent and/or well-sealed enclosure of the interior of the vehicle when the vehicle roof is closed is not guaranteed over the long term.

For this reason, folding roofs with top covers or with top materials having a synthetic basis, such as top materials with woven upper materials or PVC materials, are increasingly being used, the functionality of which is retained over a longer period of time as compared with folding leather tops.

Folding tops with upper materials that are woven or made of PVC materials, however, give a convertible vehicle a less appealing overall aesthetic impression than a vehicle that is equipped with a folding leather top, a condition that is undesirable due to the higher cost of convertible vehicles as compared with sedans, resulting from their construction.

### SUMMARY OF THE INVENTION

The object of the present invention is therefore to provide a composite material for a folding vehicle roof and a method for producing a composite material especially for a convertible vehicle, which will have a long service life, will give a convertible vehicle an exclusive and appealing overall impression especially when the vehicle roof is closed, and can be produced in a simple manner and method.

According to the invention, this object is attained with a composite material for a folding vehicle roof of a convertible vehicle according to the characterizing features of patent claim 1, and a method for producing a composite material according to the characterizing features of patent claim 5.

The composite material of the invention for a folding vehicle roof of a convertible vehicle, in which a lower layer that faces the interior of a vehicle when the vehicle roof is closed is configured at least in part as a woven textile layer, which is bonded on its side that faces away from the vehicle interior when the vehicle roof is closed to an outer leather layer via an intermediate layer, is characterized, when used in a folding top of a convertible, by a longer service life as compared with conventional leather, and gives a convertible vehicle that is equipped with a folding top, the covering material of which comprises an upper material that is woven or made of PVC material, a more exclusive and/or more individual overall look.

This is achieved with the special embodiment of the composite material to comprise a high-quality leather upper layer and the textile lower layer that is firmly bonded thereto via the intermediate layer, because this lower layer material is designed to have greater bending resistance and a greater base weight than conventional cover materials, which serves to improve the acoustics in the interior of the vehicle due to an increase in sound insulation, while simultaneously providing a high-quality visual appearance.

Employing the method according to the invention for producing a composite material comprised of a textile lower layer, an outer leather layer, and at least one intermediate layer that bonds the lower layer to the leather layer, the composite material can be produced in a simple manner and method, in which the composite material is acted upon by a level of energy, for bonding the lower layer to the leather layer, such that the intermediate layer is at least partly melted during the bonding process.

Further advantages and advantageous improvements on the object of the invention are disclosed in the description, the drawing and the patent claims.

### BRIEF DESCRIPTION OF THE DRAWING

In the drawing, an exemplary embodiment of the object of the invention is schematically illustrated in simplified form, which will be outlined in greater detail in the following description.

The sole figure of the drawing shows a composite material constructed according to the invention for a folding vehicle roof of a convertible vehicle, in a highly schematic illustration.

### DESCRIPTION OF THE PREFERRED EMBODIMENT

In the figure, an area of a composite material 1 for a folding vehicle roof of a convertible vehicle is shown, in which a lower layer that faces the interior of a vehicle when the vehicle roof is closed is configured as a woven textile layer, such as those provided with conventional top covers for folding tops on the side that faces the vehicle interior.

On the side that faces away from the vehicle interior when the vehicle roof is closed, the composite material 1 is constructed with a 0.8-mm-thick leather layer 3, which is permanently bonded to the lower layer or the textile layer 2 via a intermediate layer 4 arranged between the leather layer 3 and the lower layer 2.

The intermediate layer 4 here is constructed as a soft thermoplastic and non-reactive plastic film, the melting point of which ranges from 130° C. to 170° C., preferably approximately 150° C., which does not change during the process of bonding the lower layer 2 to the leather layer 3. Thus the plastic film can be constructed, for example, as a soft polyurethane film, with which the desired permanent bond can be produced between the lower layer 2 and the leather layer 3.

Here, the leather layer 3 is configured on its side that faces the intermediate layer 4 to have an intermediate layer 5 that impregnates the leather layer 3 and reinforces a bond between the leather layer 3 and the intermediate layer 4.

The intermediate layer also generally increases the water impermeability of the composite material 1 as compared with conventional leather folding tops, and further significantly influences the flexibility of the composite material 1. Thus the flexibility of the composite material 1 can be adjusted in a simple manner and method by varying the material used in the intermediate layer 4.

On its side that faces away from the intermediate layer 5, the leather layer 3, which is given a desired color by means of a dyeing process, during which the leather layer 3 is provided with pigmentation, is additionally provided with surface stamping, which gives the folding vehicle roof with the composite material of the invention a particularly high-quality appearance when closed.

To produce the composite material 1 illustrated in the figure, a leather layer is first provided with pigmentation during a dyeing process, and is dyed the desired shade. The dyed leather layer is then provided with the desired surface stamping using a suitable tool. To reduce residual moisture, the dyed and stamped leather layer is subjected to a curing process, during which the leather layer 3 shrinks approximately 7%.

On the side of the leather layer 3 that faces away from the side configured with the surface stamping, an impregnating intermediate layer 5 that strengthens a later bond between the intermediate layer 4 and the leather layer is applied.

The leather layer 3 that has been prepared in the above-described manner and method is then inserted together with the intermediate layer 4 and the lower layer 2 in a properly pre-heated joining machine. In the joining machine, the leather layer 3, the intermediate layer 4 and the lower layer 2 are pressed together and heated such that the intermediate layer 4 melts at least in areas that, when solidified, bond the three layers 2, 3 and 4 permanently to one another.

The composite material 1 constructed and produced in the described manner and method is designed to have a higher bending resistance and a higher base weight as compared with conventional top materials, and, in addition to a novel surface condition and/or a new appearance, is also pleasing to the touch, and is characterized by improved sound insulation.

A folding vehicle roof for a convertible vehicle constructed using the composite material of the invention gives an observer the impression of a great exclusivity and also enables a custom design for a convertible vehicle, since the composite material according to the invention can be constructed in a simple manner and method using coloring desired by the purchaser.

Of course, it is within the discretion of one of ordinary skill in the art to produce the leather layer 3 from multiple separate pieces that are sewn together if the leather pieces, which are naturally limited in size, are not large enough separately to completely cover the passenger compartment of the vehicle. Once the leather pieces have been sewn together, they can be bonded to the lower layer via the intermediate layer.

In this manner it is possible to span even large roof surfaces, such as occur, for example, in four-passenger convertibles, using the composite material, and to construct roof shapes that are complicated when the vehicle roof is closed to have the necessary taut covering.

### LIST OF REFERENCE SYMBOLS

1 Composite material

2 Lower layer, textile layer

3 Leather layer

4 Intermediate layer

5 Intermediate layer

1. Composite material (1) for a folding vehicle roof of a convertible vehicle, in which a lower layer (2) that faces the interior of a vehicle when the vehicle roof is closed is constructed at least in part as a woven textile layer, which is bonded on its side that faces away from the interior of the vehicle when the vehicle roof is closed to a leather layer (3) via a intermediate layer (4),
characterized in that on the side of the leather layer (3) that faces an intermediate layer (4), which serves to improve the water impermeability of the composite material, an intermediate layer (5) that impregnates the leather layer (3) and also serves to improve the water impermeability of the composite material along with strengthening a bond between the leather layer (3) and the intermediate layer (4), is applied.

2. Composite material according to claim 1, characterized in that the intermediate layer (4) is a soft, thermoplastic plastic film, the melting point of which ranges from 130° C. to 170° C., preferably approximately 150° C.

3. Composite material according to claim 1, characterized in that the side of the leather layer (3) that faces away from the intermediate layer (4) is configured with surface stamping.

4. (canceled)

5. Method for producing a composite material (1), which is comprised of a textile lower layer (2), an outer leather layer (3) and at least one intermediate layer (4), which bonds the lower layer (2) to the leather layer (3), wherein the composite material (1) is acted upon by a level of energy in order to bond the lower layer (2) to the leather layer (3), such that during the bonding process the intermediate layer (4) melts at least in areas,
characterized in that, before being bonded to the lower layer (2), the leather layer (3), on the side that faces the intermediate layer (4), which serves to improve the water impermeability of the composite material, is provided with an intermediate layer (5), which impregnates the leather layer (3) and both improves the water impermeability of the leather layer (3) and strengthens a bond between the leather layer (3) and the intermediate layer (4).

6. Method according to claim 5, characterized in that the composite material (1) is acted on by mechanical pressure during the bonding of the lower layer (2) to the leather layer (3).

7. Method according to claim 5, characterized in that the intermediate layer (4) is heated to between approximately 130° C. and 170° C., preferably to 150° C.

8. Method according to claim 5, characterized in that the leather layer (3) is cured prior to bonding with the lower layer (2) in order to reduce any residual moisture.

9. (canceled)

10. Method according to claim 5, characterized in that the leather layer (3), on the side that faces away from the intermediate layer (4), is provided with a stamped surface pattern created via the application of pressure.

11. Method according to claim 5, characterized in that, at least on the side of the leather layer (3) that faces away from the intermediate layer (4), pigmentation is applied.
